(19) United States
(12) Patent Application Publication
(10) Pub. No.: US 2015/0269284 A1
(43) Pub. Date: Sep. 24, 2015

(54) INTELLIGENT CHAMFER RECOGNITION IN CAD MODELS

(71) Applicant: Siemens Product Lifecycle Management Software Inc., Plano, TX (US)

(72) Inventors: Howard Charles Duncan Mattson, Cambridge (GB); Douglas Joseph King, Peterborough (GB); Michael John Gibbens, Cambridge (GB)

(73) Assignee: Siemens Product Lifecycle Management Software Inc., Plano, TX (US)

(21) Appl. No.: 14/223,292

(22) Filed: Mar. 24, 2014

(51) Int. Cl. G06F 17/50

(52) U.S. Cl. CPC G06F 17/50

(57) ABSTRACT

Methods for identifying chamfers in CAD models and corresponding systems and computer-readable mediums. A method includes applying filters to a set of candidate chamfers, the candidate chamfers identified from a plurality of faces in a CAD model, to produce filtered candidate chamfers. The method includes generating maximal chains of the candidate chamfers and grouping conflicting chains from the maximal chains to produce chain groups. The method includes determining best conflicting chains from the chain groups, including designating at least one of the chain groups as accepted. The method includes storing the faces of the CAD model that correspond to the accepted chain group as realistic chamfers.

### TECHNICAL FIELD

The present disclosure is directed, in general, to computer-aided design, visualization, and manufacturing systems (“CAD” systems), product lifecycle management (“PLM”) systems, and similar systems, that manage data for products and other items (collectively, “Product Data Management” systems or PDM systems).

### BACKGROUND OF THE DISCLOSURE

PDM systems and CAD manage PLM and other data. Improved systems are desirable.

### SUMMARY OF THE DISCLOSURE

Various disclosed embodiments include methods for identifying chamfers in CAD models and corresponding systems and computer-readable mediums. A method includes applying filters to a set of candidate chamfers, the candidate chamfers identified from a plurality of faces in a CAD model, to produce filtered candidate chamfers. The method includes generating maximal chains of the candidate chamfers and grouping conflicting chains from the maximal chains to produce chain groups. The method includes determining best conflicting chains from the chain groups, including designating at least one of the chain groups as accepted. The method includes storing the 3D faces or 2D edges of the CAD model that correspond to the accepted chain group as realistic chamfers.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIGS. 2A and 2B illustrate simple face and edge chamfers in accordance with disclosed embodiments;

FIG. 3 illustrates poor chamfer recognition using a chamfered cube;

FIGS. 4A-4E illustrate examples of some concepts in accordance with disclosed embodiments;

FIG. 5 illustrates a flowchart of a process in accordance with disclosed embodiments; and

FIG. 6 illustrates an example of a CAD model including a plurality of faces, used to illustrate the process of FIG. 5 in accordance with disclosed embodiments.

### DETAILED DESCRIPTION

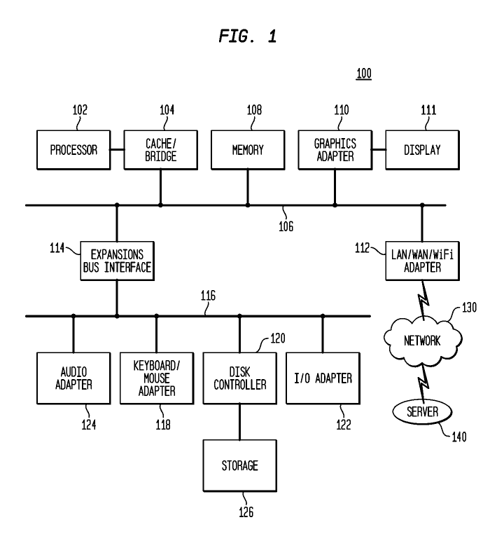

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

A chamfer is a feature in a CAD model that is applied to remove sharp edges from a part, such as by replacing a sharp “corner” intersection of two faces with an angled face. Chamfers are very commonly used as finishing features on a model, and maintaining their definition is desirable when making edits to the part.

Current chamfer recognition techniques in three-dimensional (3D) or two-dimensional (2D) CAD models are inefficient and ineffective since they tend to incorrectly identify too many entities as chamfers. Disclosed embodiments overcome this problem by intelligently identifying a subset of realistic chamfers from this larger set of potential chamfers in a consistent and efficient manner.

FIG. 1 illustrates a block diagram of a data processing system in which an embodiment can be implemented, for example as a CAD system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

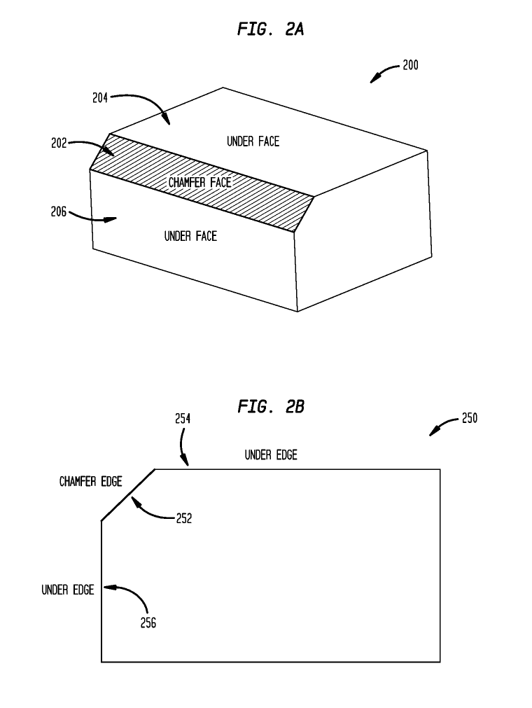

FIGS. 2A and 2B illustrate simple face and edge chamfers. FIG. 2A illustrates a simple face chamfer using 3D model 200, where a chamfer face 202 is defined between two face unders, face 204 and face 206. An “under,” as used herein, refers to each of the curves/edges (in 2D representations) or faces (in 3D representations) that underlie a blend or chamfer and on which the blend or chamfer depends; more than one “under” are “unders.” While various illustrations, descriptions, or examples may be made in terms of only 2D or only 3D models or features, the techniques described herein apply to both 2D and 3D implementations.

FIG. 2B illustrates a simple edge chamfer using 2D model 250, where a chamfer edge 252 is defined between two edge unders, edge 254 and edge 256.

When moving parts between CAD systems, or even different models or assemblies on the same system, chamfer definitions are mostly lost, so it is helpful for a CAD system to be able to automatically recognize chamfers in a part model or other model so their geometric shape can be preserved. Particularly when making a synchronous edit (or direct edit) on a model, updating any dependent chamfers allows the user to quickly change the part to get the desired result.

Basic chamfer recognition on a face or edge can be performed by checking if the face or edge fits a chamfer definition. For example, in 2D a chamfer definition can define a chamfer as a linear edge between two vertices, with two identifiable unders. In 3D, a chamfer definitions can define a chamfer as a face with a linear cross-section between two identifiable unders. All chamfers on a body can be found by checking each individual entity (face or edge) to see if it fits a chamfer definition. However this approach, in itself, tends to be problematic, in that large numbers of chamfers will be identified, including many that fit a chamfer definition but do not look like a chamfer to the user. That is, many automatically-recognized chamfers may meet a mathematical or CAD-based definition of a chamfer, but are not actually chamfers as a user would regard them. Further, many identified chamfers will conflict with their neighbors. Even in simple cases, this can be problematic.

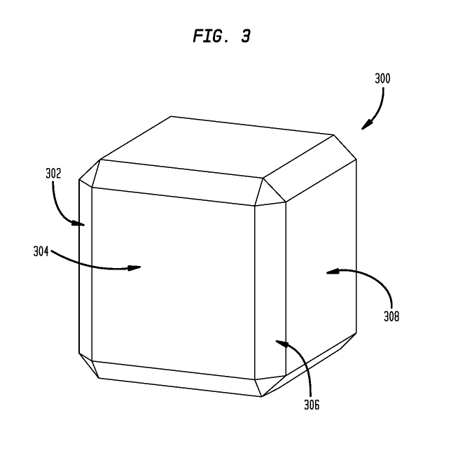

FIG. 3 illustrates poor chamfer recognition using a chamfered cube 300. In this case, all faces on the model are identifiable as chamfers since each face can be considered a chamfer of the two or more neighboring faces, particularly where the model does not include a history of the unders and chamfer formation that might define which face was created as a chamfer from which other faces. In this example, face 304 could be recognized as a chamfer between face 302 and 306, while face 306 could itself be recognized as a chamfer between face 304 and face 308, and many systems would identify these just this way, as well as identifying every other face as a chamfer between neighboring faces. Of course, to an ordinary observer or user, face 306 would be considered a chamfer but face 304 would not.

Disclosed embodiments include systems and methods that efficiently and accurately identify chamfers in 2D and 3D models in such a way that the results are actually useful to the user and reflect the user's expectations and intent. Disclosed embodiments can intelligently determine which of the potential chamfers in a given model should be treated as “realistic” chamfers. Disclosed embodiments are efficient enough to be performed as part of a dynamic edit on the model allowing chamfers to be discovered on the fly.

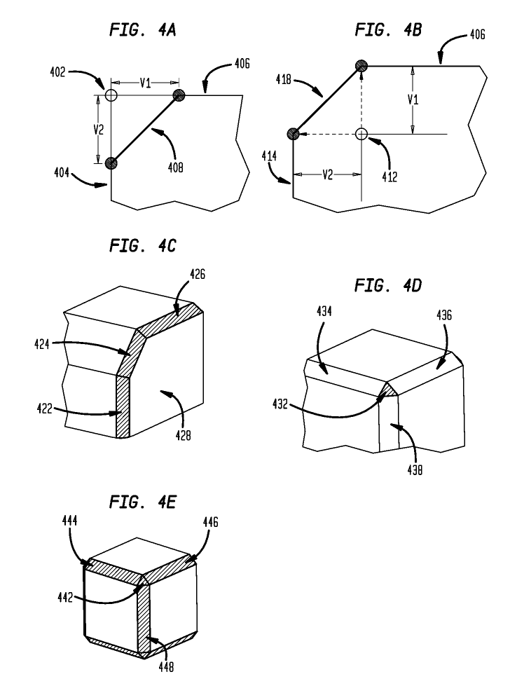

For consistency of description below, it is helpful to define some specific terms as they are used herein, and FIGS. 4A-4E illustrate examples of some concepts in accordance with disclosed embodiments. A “chamfer entity” refers to a face or edge chamfer that fits a basic chamfer definition. “Chamfer unders” refer to adjacent faces or edges between which the chamfer is defined.

“Chamfer offsets” refer to the values that define the position of the chamfer. The use of these values can vary, and the following are non-exhaustive examples. FIG. 4A illustrates a chamfer offset according to a distance from under intersection, where values v1 and v2 define the distance from the intersection 402. Note that intersection 402 is not actually present in the model, but is calculated by extending the unders (in this example, edge 404 and edge 406) of potential chamfer 408 to a point where they would intersect (intersection 402).

FIG. 4B illustrates a chamfer offset according to a distance from unders, where values v1 and v2 define offsets from the original under entities, edge 414 and edge 416. In this case the potential chamfer 418 is defined from the intersection 412 of these offsets, projected back onto the original entities. Note that intersection 412 is not actually defined in the model, but is calculated by offsetting the unders (in this example, edge 414 and edge 416) of potential chamfer 418 by the corresponding distances.

A “chamfer chain” refers to a “chain” of chamfer faces. Two adjacent chamfer faces are in the same chain if they share a common under, have the same offset values, and share a common edge. FIG. 4C illustrates a chamfer chain where chamfer faces 422 and 424 share a common under (face 428), common offset values as described above, and a common edge so must be in the same chamfer chain. Similarly, chamfer faces 424 and 426 share a common under (face 428), common offset values and a common edge so must be in the same chamfer chain. Therefore, in combination, chamfer faces 422, 424, and 426 form a single chamfer chain.

A “branch chamfer” refers to a chamfer face that is adjacent to more than two chamfers. FIG. 4D illustrates a branch chamfer where chamfer face 432 is adjacent to chamfer faces 434, 436, and 438. Chamfer face 432 is a branch chamfer because it links together three branches of a network of chamfer chains.

A “maximal chain” is a chamfer chain that includes all branch faces and follows all branches. FIG. 4E illustrates a maximal chain including branch face 442 and adjacent chain faces 444, 446, and 448.

Dependency generally refers to the geometric dependency between two features that defines how the dependent feature is or was formed. A chamfer entity is dependent on its unders. Two chamfer entities A and B are mutually dependent if A is an under of B and B is an under of A. Two chamfer chains A and B are mutually dependent if a chamfer entity in A is dependent on a chamfer entity in B and the same chamfer entity in B is dependent on the same chamfer entity in A. A maximal chamfer chain can be mutually dependent with another maximal chamfer chain.

“Conflicting chains” refers to two chains that are mutually dependent; mutually dependent chains conflict in the embodiments disclosed herein.

“Global finding” refers to finding all chamfers on a given model, sometimes referred to as “whole model” or “batch” finding. This process can be used, for example, to identify and store all chamfers in a model following import of that model.

“Local finding” refers to finding all relevant chamfers to a given entity. This can be used, for example, for “on the fly” chamfer identification to avoid considering the whole model, such as when no storage of chamfer data exists and local edits are being made on a model.

Disclosed embodiments use the wider part context of the chamfer to make choices on which entities will be considered realistic chamfers. Processes as disclosed herein provide multiple advantages. For example, disclosed embodiments avoid over-recognition in that many entities could be treated as chamfers, but far fewer would generally be regarded as real chamfers. Disclosed embodiments can be implemented in local and global processes. Local finding is typically used dynamically when editing a model and is only required to recognize sufficient chamfers to perform the edit and the chamfer information may be kept or discarded afterward. Global finding might be done, for example, when first loading a model which has no chamfer information. The requirement is to recognize all the reasonable chamfers on a model and maintain the information for subsequent use when editing.

Disclosed embodiments can use criteria that are absolute (such as local sizes and ratios) and avoid contextual criteria (such as frequency of offset values found within the input). This can ensure consistency in results. Disclosed embodiments make the same decision on each entity regardless of whether the overall input/context is a single entity or a whole part. For use in synchronous technology, this means that results and behaviors are the same regardless of whether the Local or Global methods (as defined above) are used. This also ensures efficiency. A simplistic way to achieve consistency would be to have the local finding process simply call the global finding process and extract the small portion of information it needs. However, this would be inefficient. Due to the absolute criteria, this local method can explore a small local portion of the model as required in the knowledge the result will be consistent regardless.

Disclosed embodiments incorporate conflict handling. Often neighboring entities could each be regarded as a chamfer but treating both as chamfers would not be useful. Disclosed embodiments can resolve conflicts using the same potential set of absolute criteria as are available for avoiding over-recognition.

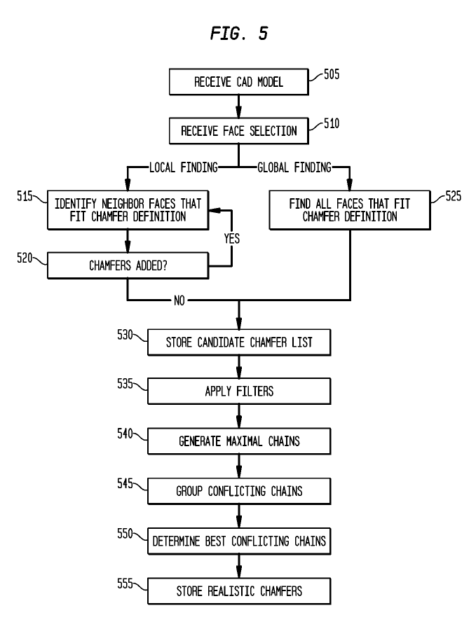

FIG. 5 illustrates a flowchart of a process in accordance with disclosed embodiments that may be performed, for example, by one or more PLM, PDM, or CAD systems as described herein, referred to below generically as the “system.”

The system receives a CAD model including a plurality of faces (505). Note that in 2D implementations, a similar process is used but applied to edges, and the description of this process with respect to faces is intended to apply to edges and edge chamfers as well. Receiving, as used herein, can include loading from storage, receiving from another device or process, receiving via an interaction with a user, and otherwise.

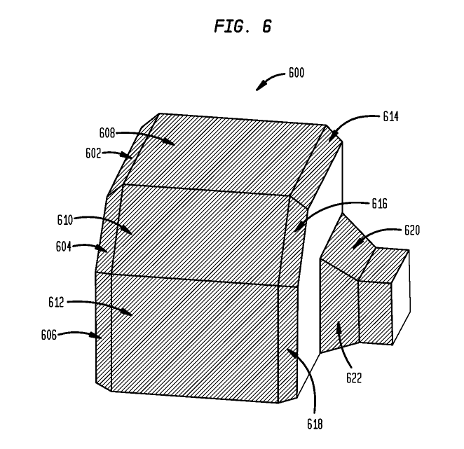

FIG. 6 illustrates an example of a CAD model 600 including a plurality of faces, and can be used to illustrate the process of FIG. 5. In this figure, all of the numbered faces could be recognized as chamfers using a chamfer definition, but it is clear that the thinner chamfers (faces 602, 604, 606, 614, 616, and 618) are more realistic.

An exemplary process in accordance with disclosed embodiments includes two primary stages: determination of the candidate chamfers and deciding which of the candidates are realistic. The second stage is common to both global and local finding and allows consistent decision making between the two. The first stage is different for local and global finding. Within the context of local finding, to aid efficiency the combined results of stage 1 and stage 2 can be cached. This is possible because both processes are deterministic.

The system receives a face selection (510). In a global finding process, this is a selection of all faces in the model, and can be accomplished simply by receiving a user selection of a global chamfer finding process. In a local finding process, this is a selection of a single “seed” face, and can be accomplished by receiving the user selection of the seed face or by receiving any particular face which a calling algorithm needs to know is a chamfer or not. Face 610, for example, could be the seed face if selected.

In the example of FIG. 6, assume that all eighteen faces (some backward facing in the figure) of the CAD model 600 are selected for a global finding process.

In a local finding process, the system performs a breadth-first-search from the selected seed face to identify all topologically adjacent “neighbor” chamfers that meet a chamfer definition (515) and adds these chamfers to a candidate chamfer list. If any chamfer entities were identified (520), any neighbor features (faces) to that chamfer entity is added to a seed list and the local finding process repeats to 515 to identify further chamfers until the seed list is empty. The process then proceeds to 530.

In a global finding process, all candidate chamfers are identified by comparing each face in the CAD model to the chamfer definition (525). The process then proceeds to 530. In the example of FIG. 6, all of the numbered faces are identified as candidate chamfers.

Local finding processes 515 and 520 are generally alternatives to global finding process 525, as illustrated in FIG. 5.

The system stores the candidate chamfer list of all identified candidate chamfers (530). In the example of FIG. 6, all of the numbered faces are identified and stored in the candidate chamfer list.

Processes 505-530 generally represent the first-stage process alternatives, and the remaining processes represent the second-stage processes. The second-stage processes the finding of realistic chamfers from among a set of candidate chamfers. This process receives a set of entities (faces or edges, the “candidate chamfer list” is used in this process example) that are known to be potential chamfers and will make a decision on each entity given. The output is a subset of the input entities which are considered to be realistic chamfers.

The system applies filters to the set of candidate chamfers in the candidate chamfer list (535) to produce filtered candidate chamfers. The candidate chamfer list has a plurality of candidate chamfers that were identified from the plurality of faces in the CAD model, and 535 can include receiving the candidate chamfer list (particularly in cases where the first stage and second stage are not performed together).

Applying the filters (535) and determining best conflicting chains (550, below) can use various properties of the candidate chamfer entities to filter out unwanted chamfers and decide which chamfers are best. That is, the system applies filters to the set of candidate chamfers by applying one or more properties to the candidate chamfers. Examples of these properties are listed below in Table 1. Each property can potentially be applied in one or both situations to give differing outputs. These properties could be inbuilt in the system, or provided by the user, and can be selected automatically or selected by a user. In practice a selection are applied in each stage to tune which chamfers are considered realistic.

| | | Example use in ‘best’ |
|---|---|---|
| Property | Example use in filtering | decisions |
| Chamfer type | Ignore unwanted types | Prefer cone chamfers |
| Chamfer width | Ignore large chamfers | Prefer thinner chamfers |
| Chamfer area | Ignore large chamfers | Prefer smaller chamfers |
| Chamfer offsets | Ignore non-symmetric | Prefer smaller chamfers |
| | chamfers | |
| | Ignore chamfers outside a | |
| | given range | |
| Chamfer offset/model size | Ignore large chamfers | Prefer smaller chamfers |
| ratio | | |
| Chamfer offset/local box ratio | Ignore large chamfers | Prefer smaller chamfers |
| Chamfer alignment | Ignore chamfers aligned to the | Prefer non-aligned chamfers |
| | X-Y-Z axes of the part | |
| Chamfer aspect ratio | Ignore large chamfers | Prefer thinner chamfers |
| Chamfer width/under width | Ignore large chamfers | Prefer thinner chamfers |
| ratio | | |
| Chamfer chain length | Ignore individual chamfers | Prefer longer chains |
| Angle between unders | Ignore non 45 degree chamfers | Prefer 45 degree chamfers |
| | Ignore angles outside a given | |
| | range | |
| Length of edges between under | Ignore chamfers with small | Prefer larger unders |
| and chamfer | unders | |
| Under alignment | Ignore chamfers whose unders | Prefer aligned unders |
| | are not aligned to the X-Y-Z | |
| | axes of the part | |
| Concave/Convex | Ignore convex chamfers | Prefer concave chamfers |

Each potential chamfer has any of the various filters outlined above applied at 535 to determine its suitability as a chamfer. Some examples could include the angle between the unders being greater than a specified value (e.g. 5 degrees), the edges between under and chamfer face must be at least a specified amount of the chamfer face (e.g. 90%), the chamfer offset sizes are less than a given percentage of the model (e.g. 50%), or the chamfer offset sizes are within a given range of sizes. As part of applying the filters, any candidate chamfers that do not match the applied filters can be removed from the candidate filter list. The candidate chamfers that do match the applied filters are filtered candidate chamfers.

In the example of FIG. 6, assume that the applied filters are to remove all concave chamfers (face 620 and face 622 in this example) and all non-equal offset chamfers. The nine filtered candidate chamfers are then faces, 602, 604, 606, 608, 610, 612, 614, 616, and 618.

The system generates maximal chains from the candidate chamfers on the candidate chamfer list (540). Here, the filtered candidate chamfers (or the remaining candidate chamfers on the candidate chamfer list) are grouped into maximal chains within the CAD model. The maximal chains can chamfer chains of candidate chamfers that include all branch faces and all branches in the chamfer chain.

In the example of FIG. 6, this produces four maximal chains: Chain 1 is faces 614, 616, and 618. Chain 2 is faces 608, 610, and 612. Chain 3 is faces 602, 604, and 606. Chain 4 is face 610.

The system groups conflicting chains from the maximal chains (545) to produce chain groups. The set of maximal chains is divided into subsets of mutually dependent chains. To be in a subset a chain must be mutually dependent with at least one other chain in the subset. The set of chains is fully partitioned into subsets, therefore any subsets whose size is greater than 1 are a set of mutually dependent chamfer chains.

In the example of FIG. 6, the following groups of conflicting mutually dependent chains are created: Group 1 includes chains 1, 2, and 3, and group 2 includes chain 4.

The system determines the best conflicting chains (550). Each set of mutually dependent chamfer chains is processed to choose the best chamfer chains, such as by the applying one or more properties to the chain groups in an order of preference. These properties could be inbuilt in the system, or provided by the user, and can be selected automatically or selected by a user. This can proceed, for example, as follows: While “unprocessed” chains exist, the system sorts the ‘unprocessed’ chains based on preference, best chamfer chain first. If there are multiple best chamfers chains (i.e. the preference ordering could not determine which is better), the system marks any mutually dependent pairs within the set of best chamfer chains are set as “rejected,” and others within the set are marked as “accepted.” Of course, other labels could be used. Otherwise, the system marks the first chamfer chain in the sorted set as “accepted” and marks all of its dependents as “rejected” then continues to process the unprocessed chains.

The best chamfer chain can be determined, for example, using a selection of the properties outlined above in Table 1, defined in order of preference. An example list would be the following: Length of the chamfer chain, longer chains are best; then chamfer unders are horizontal or vertical, more aligned unders are better; then chamfer at 45 degrees to principle directions, aligned to more directions is best; then under angle, unders at 90 degrees are better; then chamfer type, cone chamfers in preference to plane or cylinder; then aspect ratio, longer and thinner is better; then chamfer width/combined under width ratio, smaller is better; then chamfer width, smaller is better; then chamfer area, smaller is better.

The system stores faces of the CAD model corresponding to the accepted chains as realistic chamfers (555).

In the example of FIG. 6, assume that the applied preferences are to prefer longer and thinner chamfer faces. The best chains within group 1 are determined to be the following: First preference is Chain 1 and chain 3 equally; second preference is Chain 2.

Within the first preference, chain 1 and chain 3 are not mutually dependent on each other so are both “accepted,” and their dependents, chain 2, are “rejected,” leaving the faces of chains 1 and 3 as the candidate chamfers.

The completed process has therefore identified faces 602, 604, 606, 614, 616, 618 and 610 as realistic chamfers. These realistic chamfers are stored as associated with the CAD model 600.

Of course, those of skill in the art will recognize that, unless specifically indicated or required by the sequence of operations, certain steps in the processes described above may be omitted, performed concurrently or sequentially, or performed in a different order.

According to various embodiments, identified chamfers can be or are filtered as described herein, and can have had preferences applied for mutually-dependent cases. There can be consistency between local and global finding, and local finding is efficient enough to be used within real-time modelling operations.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method performed by at least one data processing system and comprising:
applying filters to a set of candidate chamfers, the candidate chamfers identified from a plurality of faces in a CAD model, to produce filtered candidate chamfers;
generating maximal chains of the candidate chamfers;
grouping conflicting chains from the maximal chains to produce chain groups;
determining best conflicting chains from the chain groups, including designating at least one of the chain groups as accepted; and
storing the faces of the CAD model that correspond to the accepted chain group as realistic chamfers.

2. The method of claim 1, wherein the system also receives the CAD model and performs a local finding process to produce the candidate chamfers, including identifying all faces that are topologically adjacent to a seed face and that meet a chamfer definition as candidate chamfers.

3. The method of claim 1, wherein the system also receives the CAD model and performs a global finding process to produce the candidate chamfers, including identifying all faces in the CAD model that meet a chamfer definition as candidate chamfers.

4. The method of claim 1, wherein the system applies filters to the set of candidate chamfers by applying one or more user-selected properties to the candidate chamfers.

5. The method of claim 1, wherein the maximal chains are chamfer chains of candidate chamfers that include all branch faces and all branches in the chamfer chain.

6. The method of claim 1, wherein the chain groups are chamfer chains of mutually dependent chamfers.

7. The method of claim 1, wherein the best conflicting chains are determined by applying one or more user-selected properties to the chain groups in an order of preference.

8. A data processing system comprising:
a processor; and
an accessible memory, the data processing system particularly configured to
apply filters to a set of candidate chamfers, the candidate chamfers identified from a plurality of faces in a CAD model, to produce filtered candidate chamfers;
generate maximal chains of the candidate chamfers;
group conflicting chains from the maximal chains to produce chain groups;
determine best conflicting chains from the chain groups, including designating at least one of the chain groups as accepted; and
store the faces of the CAD model that correspond to the accepted chain group as realistic chamfers.

9. The data processing system of claim 8, wherein the system also receives the CAD model and performs a local finding process to produce the candidate chamfers, including identifying all faces that are topologically adjacent to a seed face and that meet a chamfer definition as candidate chamfers.

10. The data processing system of claim 8, wherein the system also receives the CAD model and performs a global finding process to produce the candidate chamfers, including identifying all faces in the CAD model that meet a chamfer definition as candidate chamfers.

11. The data processing system of claim 8, wherein the system applies filters to the set of candidate chamfers by applying one or more user-selected properties to the candidate chamfers.

12. The data processing system of claim 8, wherein the maximal chains are chamfer chains of candidate chamfers that include all branch faces and all branches in the chamfer chain.

13. The data processing system of claim 8, wherein the chain groups are chamfer chains of mutually dependent chamfers.

14. The data processing system of claim 8, wherein the best conflicting chains are determined by applying one or more user-selected properties to the chain groups in an order of preference.

15. A non-transitory computer-readable medium encoded with executable instructions that, when executed, cause one or more data processing systems to:
apply filters to a set of candidate chamfers, the candidate chamfers identified from a plurality of faces in a CAD model, to produce filtered candidate chamfers;
generate maximal chains of the candidate chamfers;
group conflicting chains from the maximal chains to produce chain groups;
determine best conflicting chains from the chain groups, including designating at least one of the chain groups as accepted; and
store the faces of the CAD model that correspond to the accepted chain group as realistic chamfers.

16. The computer-readable medium of claim 15, wherein the system also receives the CAD model and performs a local finding process to produce the candidate chamfers, including identifying all faces that are topologically adjacent to a seed face and that meet a chamfer definition as candidate chamfers.

17. The computer-readable medium of claim 15, wherein the system also receives the CAD model and performs a global finding process to produce the candidate chamfers, including identifying all faces in the CAD model that meet a chamfer definition as candidate chamfers.

18. The computer-readable medium of claim 15, wherein the system applies filters to the set of candidate chamfers by applying one or more user-selected properties to the candidate chamfers.

19. The computer-readable medium of claim 15, wherein the maximal chains are chamfer chains of candidate chamfers that include all branch faces and all branches in the chamfer chain.

20. The computer-readable medium of claim 15, wherein the chain groups are chamfer chains of mutually dependent chamfers and the best conflicting chains are determined by applying one or more user-selected properties to the chain groups in an order of preference.
